(19) United States
(12) Patent Application Publication
(10) Pub. No.: US 2022/0151269 A1
(43) Pub. Date: May 19, 2022

(54) DARK BROWN CARAMEL COLOR

(71) Applicant: The Williamson Group, Inc., Louisville, NY (US)

(72) Inventor: Bryan Aviles, Louisville, KY (US)

(21) Appl. No.: 17/439,142

(22) PCT Filed: Mar. 16, 2020
(86) PCT No.: PCT/US2020/022970

§ 371 Date: Sep. 14, 2021

Related U.S. Application Data
(60) Provisional application No. 62/819,104, filed on Mar. 15, 2019.

(51) Int. Cl. A23L 5/48; A23G 3/22

(52) U.S. Cl. CPC A23L 5/48; A23G 3/22

(57) ABSTRACT

A process for preparing a caramel color using a sugar source, further incorporating into the color-making process a food-grade spacing agent, and a caramel color.

### CROSS-REFERENCE TO RELATED APPLICATIONS

This application claims the benefit of and priority to prior filed pending Provisional Application Ser. No. 61/819,104, filed Mar. 15, 2019, which is expressly incorporated herein by reference.

### FIELD OF THE INVENTION

The invention relates to a process for preparing a caramel color, and a colored material having a low hue index, acid stability, beer stability, sodium, calcium or potassium chloride stability and improved shelf life.

### BACKGROUND OF THE INVENTION

Caramels are a primary color component added to food products. They are the world's most widely consumed food coloring ingredient on a weight basis. The caramel color is the dark brown material resulting from the carefully-controlled heat treatment of food-grade carbohydrates capable of undergoing caramelization and maillard browning.

Due to the wide variety of food products and applications of use for color components, several different caramel colors are required. There are four general classifications of caramel. Caramel Color I or Class I, also known as plain or spirit caramel, is a burnt sugar caramel which is formed without ammonium or sulfonium compounds. This is also classified as an E-150a color. Caramel Color II (E-150b), also referred to as caustic sulfite caramel, is formed with sulfonium compounds but in the absence of ammonium compounds. Caramel Color III (E-150c), also referred to as ammonia or beer caramel, as well as baker's confection caramel, is formed with ammonium compounds but without sulfonium compounds. Caramel Color IV (E-150d), also known as sulfite ammonia caramel or soft drink caramel or acid proof caramel, utilizes both ammonium and sulfonium compounds in the production of a caramel.

The various classes of caramel color, in addition to differences in ingredients and in manufacturing procedures, also have different color properties. These properties, known as color intensity and hue index, generally correlate to the intensity of the color and the degree of yellowness observed in the color. A liquid Class I caramel color or a burnt sugar will generally have a color intensity in the range of 0.010-0.054 (an absorbance at 610 nm of a 0.1% weight/volume solution in deionized water (ABS)). The hue index (10 times the log of the absorbance at 510 nm divided by absorbance at 610 nm of a 0.1% weight/volume solution in deionized water) of a Class I caramel color or a burnt sugar is typically greater than 5 and less than 9 but typically greater than 5.5 and typically less than 7. In comparison, a liquid Class IV caramel color typically has a color intensity of 0.250 ABS, approximately five times higher and a hue index between 3.5-5 and most commonly between 3.9-4.5. Thus, the Class IV caramel colors can be used in a product at 20% the concentration of a Class I caramel color or burnt sugar and there is no current way to match the color intensity and hue index of a Class IV with that of a Class I caramel color, burnt sugar or other carbohydrates not containing added sulfonium or ammonium ingredients.

Due to the different methods of manufacturing and starting ingredient formulations, each of the caramel colors produce different chemical compounds, although they are not well-defined. Caramel colors formed with ammonium compounds tend to have nitrogen-containing compounds and those formed with sulfonium include sulfur-containing compounds. For example, Class IV and Class III caramels often include minor amounts of 4-methylimidazole, also referred to as 4-Mel. 4-Mel is a heterocyclic organic chemical compound which may be formed in the process of making caramel coloring using ammonium-based processes. It is generally preferable to form a caramel product that has as little or no 4-Mel as possible. U.S. Pat. No. 9,565,866 discloses a method to minimize the amount of 4-Mel in Class IV caramels. The use of sulfonium and ammonium containing compounds within the class IV caramel color formulation allows for industry leading stability in acidic environments such as soft drinks (typically pH 1-2.7). In Class III caramel formulations, the ammonium containing compounds such as ammonium hydroxide make this caramel color very stable in food environments with high sodium, calcium or potassium chloride loads and positively charged proteins. Class III caramel colors are used in beer and soy sauce applications. Class I caramels and burnt sugars, on the other hand, use no ammonium or sulfonium containing ingredients in the manufacturing process. Due to the method of manufacture, known Class I caramels and burnt sugars cannot be used with high acid-containing liquids such as soft drinks without precipitation of the color. Known Class I caramels can also not be used in fermented beverages or in foods with high sodium, calcium or potassium chloride environments such as soy sauce or electrolyte drinks without precipitation of the color in application.

Class II Caramel Colors have a negative colloidal charge show good stability in alcoholic beverages and baked goods. They are typically used in breads, spirits, dairy beverages, and confections. US Patent application 2017052444 describes a low hue, class II caramel color which requires the use of sulfonium compounds. Class III caramel color is not used with soft drinks due to instability, but are stable in high sodium, calcium or potassium chloride applications. Class IV caramel color is suitable for use in soft drinks and dark brown bakery applications such as rye bread. In all classes of caramel and burnt sugars it is beneficial to generate as much color as possible without sacrificing the key color, stability and usability parameters of the ingredient. Viscosity after color generation is a key indicator as to what shelf life the material will have. A lesser viscosity at the beginning of shelf life correlated to longer shelf life.

The manufacture of each Class IV caramel color relies on the use of sulfonium and ammonium containing compounds such as ammonium hydroxide and sodium sulfite. Typical class IV caramel color is produced in a controlled cooking reaction with the use of pressure and temperatures between 250-300° F. (121.1 to 148.9° C.). Adding more ammonium and sulfonium sources can help increase the color reaction but typically lead to unacceptable sulfite levels in the final product or unreacted ammonium compounds. The Class IV reaction is accelerated with more acidic conditions and inhibited by higher pH environments. These conditions can be achieved with food grade acids and bases. A test for accelerated shelf life is the resinification test. In this test a glass vial is filled with caramel color and exposed to 100 degrees C. until the caramel color will no longer flow once inverted (failure). A 40-45 hour hold prior to failure corresponds to 2-year useable shelf life.

Class III caramel colors are cooked using sugar and ammonium containing ingredients such as ammonium hydroxide. The benefit of this class of caramel is their stability in foods with high sodium, calcium or potassium chloride loads and/or positively charged proteins; this is why Class III caramel colors are using in beer and soy sauce applications. Class III caramel color has a higher hue index than class IV caramel colors but typically lower than class I caramel colors or burnt sugars. As the cook progresses and color develops, typically under 0-20 psi environments. The Class III reaction is accelerated with more basic conditions and inhibited by lower pH environments. These conditions can be achieved with food grade acids and bases. As the class III caramel color ages, it also continues the reaction at ambient storage conditions. While the usable shelf life of class III caramel colors is typically 1-2 years under ambient storage conditions, improvements to delay these effects would be of benefit to the industry.

Class 1 caramel colors are produced by heating a carbohydrate source. No sulfonium or ammonium containing compounds are permitted in order for this classification. The color development is accelerated through the use of bases such as sodium hydroxide. Small amounts of acids are typically used in order to hydrolyze starches and sugars into monomeric sugars that can caramelize. This acid hydrolysis has to be neutralized because heating a sugar syrup to caramelization temperatures in an acidic environment produces haze and insoluble particles. The acidic environment also slows color development. Burnt sugar caramelization is also similar but is not allowed to have bases such as sodium hydroxide to accelerate the browning reaction.

Class I caramel color, class II caramel colors and burnt sugars are limited in replacing Class IV and Class III caramel compositions due to their low color intensity; their instability in beer, acidic environments and in concentrated sodium, calcium or potassium chloride food products; and their high hue index. Class I colors and burnt sugars do not have the stability in beer, sodium, calcium or potassium chloride or acidic beverage environments compared to Class IV and Class III caramels.

### SUMMARY OF THE INVENTION

The present invention provides a way to increase the stability and color development of all classes of caramel color burnt sugars and cooked plant juice carbohydrates.

The present invention provides a dark brown Class I caramel color and burnt sugar which is acid-stable, salt stable (sodium, calcium or potassium chloride-stable) and beer-stable. The caramel color has a high color intensity and low Hue index, making it suitable for a wide variety of different applications. Further, because the caramel color is formed without nitrogen-containing components, no 4-Mel is produced. Also, other undesirable compounds such as furfuryl alcohol are not produced. The caramel color during manufacture is less susceptible to viscosity increase, and is less likely to solidify under the reaction conditions and during storage. The present invention also provides a way to increase the stability and color development of all four classes of caramel color, burnt sugars, and cooked plant juice carbohydrates.

The present invention provides a method of manufacturing a Class I caramel color or burnt sugar with all the above characteristics by heating an acidic mixture of a sugar and a spacing agent for an amount of time effective to form the caramel color, burnt sugar or cooked plant juice carbohydrates. The spacing agent separates the browning sugar molecules during the reaction, allowing byproducts, such as gases and the like, to escape during the reaction process. This in turn prevents formation of extremely large caramelized molecules that, if allowed to form, would interfere with the cooker and the caramelization process, eventually stopping the reaction altogether before the caramel would achieve the desired color intensity.

The invention also further relates to a process for producing a brown caramelized color having a hue index less than 4.5, in the presence of a spacing agent wherein the reaction takes place between the pressure/temperature equivalents of −20 and 60 psi/245-300° F. (118.3 to 148.9° C.), and within a defined pH band of −0.5 and 2.5. Neither added sulfonium nor ammonium containing ingredients are incorporated into the starting materials to produce this brown color.

The invention also further relates to a process for producing a brown class I caramel color, burnt sugar or cooked plant juice having a hue index of less than 4.5 which is acid beverage stable, beer stable and 20% weight/weight sodium, calcium or potassium chloride stable, in the presence of a spacing agent wherein the reaction takes place between the pressure/temperature equivalents of −20 and 5 psi/245-350° F. (118.3 to 176.7° C.), and within a defined pH band of 0.5 and 2 through the use of a food grade acid. Neither added sulfonium nor ammonium containing ingredients are incorporated into the starting materials to produce this brown color.

The spacing agent is typically a non-browning, food-grade component that is either liquid or water soluble. It can be used at the beginning of the cook, dosed throughout the cook or dosed through part of the cook. Exemplary spacing agents include polyols such as glycerol, mannitol, sorbitol, xylitol, erythritol, low dextrose equivalence (DE) sugar syrups, and food-grade oils or lipids, which are stable at reaction temperatures. Ingredients that undergo caramelization and maillard browning can be used as the typical browning ingredients in the present invention, including glucose, fructose, high DE corn syrup, sucrose, xylose, plant juices, syrups and extracts containing reducing sugars, combinations of these ingredients, and the like. The acids typically used to adjust the pH are hydrochloric acid, phosphoric acid, citric acid, ascorbic acid and the like.

The invention also relates to a process for producing caramel color wherein the typical ingredients used in a class I caramel color are combined with a spacing agent in cooking class I caramel color products with greater color intensities, and lower viscosities than previously achievable without the spacing agent.

The invention also relates to a process for producing caramel color wherein the typical browning ingredients used in a class IV caramel color are combined with a spacing agent in cooking class IV caramel color product with greater color intensities, lower viscosities and longer resinification times than previously achievable without the spacing agent.

The invention also relates to a process for producing caramel color wherein the typical browning ingredients used in a class III caramel color are combined with a spacing agent in cooking class III caramel color products with greater color intensities, lower viscosities and greater sodium, calcium or potassium chloride and beer stability than previously achievable without the spacing agent.

The invention also relates to a process for producing caramel color wherein the typical browning ingredients used in a class II caramel color are combined with a spacing agent in cooking class II caramel color products with greater color intensities and lower viscosities than previously achievable without the spacing agent.

### DETAILED DESCRIPTION OF THE INVENTION

The invention in its broader aspects relates to a method of forming a brown ingredient or additive comprising heating a browning ingredient source in the presence of a non-browning food-grade spacing agent for a time, and at a temperature which is effective to produce a high color intensity brown color in the absence of any added reactive sulfonium or ammonium compounds. The reaction conditions generally span pressure/temperature equivalents of −20 and 80 psi/245-350° Fahrenheit (116.3 to 176.7° C.), and within a defined pH band −0.5 and 2.5, to produce a dark brown low hue brown color. A representative composition for the brown color will include a browning ingredient in a weight percentage of 3 to 98%; a spacing agent in the weight concentration of 1 to 90%, and an acid concentration of 0.002% to 20.0%. The spacing agent concentration by weight can be up to—80%, or 70%, or 60%, or 50%, or 40%, or 30%, or 20%, or 10%. For each of the Class I-IV products described herein, the color can be dried into a powder with the same stability benefits and with an increase in the color per gram proportional to the removal of water.

Further disclosed is a brown color comprising a Class I caramel, burnt sugar or cooked plant juice in combination with a spacing agent wherein the spacing agent is a non-browning food grade composition that is stable at temperatures of 220 to 450° F. (104.4 to 232.2° C.), further wherein the caramel color, burnt sugar or cooked plant juice is produced with the spacing agent under the pressure/temperature equivalents of −20 and 5 psi/245 to 300° F. (118.3 to 148.9° C.) and within a pH band of −0.5 to 2.5, and further wherein the brown color ingredient is stable in acidic beverages with pH up to 7 and in another embodiment within the pH range of 0.25 to 2.7, beer and up to 30%, or from 10 to 20% weight/weight sodium, calcium or potassium chloride stable in the absence of added reactive sulfonium or ammonium compounds in the brown compositions. Salt stability would encompass systems containing as low as 1% sodium, calcium or potassium chloride in contact with the brown color ingredient, or between 1 and 5%, or between 1 and 10%, or between 10 and 15%, weight/weight of the salt. Typically a liquid Class I caramel color has a maximum color intensity of 0.080 with a solids content of 63%. This process allows for a liquid class I caramel color to be produced with color intensity of up to 0.600, or up to 0.450, or up to 0.350, or up to 0.250, or up to 0.150, or up to 0.100, with a solids content up to 80% by weight, or within a weight range of 20% to 80%. A representative composition for the brown color will include a browning ingredient in a weight percentage of 3 to 98%; a spacing agent in the weight concentration of 1 to 90%, and an acid concentration of 0.002% to 20.0%.

Further disclosed is a brown color comprising a Class IV caramel , wherein the caramel color is produced with the spacing agent wherein the spacing agent is a non-browning food grade composition that is stable at temperatures of 220 to 450° F. (104.4 to 232.2° C.) under typical class IV caramel color reaction parameters, and further wherein a greater color intensity, greater shelf-life stability and greater resinification stability caramel color can be produced. Typically a liquid Class IV caramel color has a maximum color intensity of 0.280 with a solids content of 53%. This process allows for a liquid Class IV caramel color to be produced with color intensity of up to 1.000, or up to 0.800, or up to 0.500, or up to 0.0400, or up to 0.350, or up to 0.300, with a solids content up to 80% by weight or within a weight range of 20% to 80%. Typically a liquid Class IV caramel color with a color intensity of 0.250 has a resinification time of 40 hours. This process allows for a liquid Class IV caramel color to be produced with resinification time of up to 400 hours, or up to 200 hours, or up to 100 hours, or up to 60 hours, with 0.250 color intensity. This process also allows for a liquid Class IV caramel color to be produced with resinification time of up to 350 hours, up to 180 hours, up to 80 hours, or up to 50 hours with a 0.300 color intensity. This process also allows for a liquid Class IV caramel color to be produced with resinification time of up to 300 hours, or up to 130 hours, or up to 50 hours, or up to 20 hours with a 0.400 color intensity.

Further disclosed is a brown color comprising a Class III caramel in combination with a spacing agent wherein the spacing agent is a non-browning food grade composition that is stable at temperatures of 220 to 450° F. (104.4 to 232.2° C.), further wherein the caramel color is produced with the spacing agent under typical class III caramel color reaction parameters, and further wherein a greater color intensity, storage stability and greater sodium, calcium or potassium chloride and beer stability caramel color can be produced. Typically a liquid Class III caramel color has a maximum color intensity of 0.220 with a solids content of 60%. This process allows for a liquid Class III caramel color to be produced with color intensity up to 0.500, or up to 0.400, or up to 0.350, or up to 0.250 with solids content of up to 80% by weight, or within a range of 20% to 80%.

Further disclosed is a brown color comprising a Class II caramel in combination with a spacing agent wherein the spacing agent is a non-browning food grade composition that is stable at temperatures of 220 to 450° F. (104.4 to 232.2° C.), further wherein the caramel color is produced with the spacing agent under typical class II caramel color reaction parameters, and further wherein a greater color intensity and greater shelf-life stability caramel color can be produced. Typically a liquid Class II caramel color has a maximum color intensity of 0.060 with a solids content of 65%. This process allows for a liquid Class II caramel color to be produced with color intensity of up to 0.600, or up to 0.300, or up to 0.200, or up to 0.150, or up to 0.100 with solids content of up to 80% by weight, or within a range of 20% to 80%.

The process for producing the particular brown colors incorporates a spacing agent component which does not react with the browning ingredients to produce brown color under the reaction conditions. The spacing agent can be selected from a range of materials which are food grade, are non-browning at reaction temperatures up to 450° F. (232.2° C.) and which are not susceptible to degradation under mild pressurization conditions of up to 80 psi. The concentration of the spacing agent in the reaction mixture is preferably 5-95% and most preferably 10-50%.

Acceptable spacing agents include polyols, plant juices, oligosaccharides, and certain oils and fats. Representative polyols include: glycerol, erythritol, mannitol, sorbitol (glucitol), arabitol, xylitol, lactitol, arabinitol, galactitol (dulcitol), ribitol, isomalt, and hydrogenated starch hydrolysates, and combinations of these polyols.

Representative plant juices include: pear, prune, peach, and cherry juice concentrates. These polyol sources contain both carbohydrates that can be browned and levels of spacing agent polyols, such as sorbitol. Polyol levels in these juices are typically between 5 and 90% of the juice solids, alternately between 5 and 50%, between 5 and 25%, between 5 and 13%, and between 6 and 8% juice solids.

Representative oligosaccharides are carbohydrate syrups with dextrose equivalence [DE] values between 15 and 70. In another embodiment the DE is between 40 and 60. Typically, the oligosaccharides consist of carbohydrates with a degree of polymerization greater than 3 and less than 1000. In another embodiment the degree of polymerization is greater than 4 and less than 100. Under the reaction conditions normally experienced in forming the caramel colors, the oligosaccharide compounds are hydrolyzed into smaller oligosaccharides during the cooking process, but will still act as a low reactivity medium and can continue to be introduced to the cooking system as that hydrolysis reaction continues. Representative oligosaccharides are: 18 DE maltodextrin, 36 DE corn syrup solids, 42 DE corn syrup solids, 43 DE corn syrup, and maltose syrups, and combinations of these oligosaccharides.

Another type of spacing agent is an edible grade oil or fat. The oils preferably are refined oils, and those with high smoke points. Most of the oils have smoke points between 390° F. and 465° F. (198.9 and 240.5° C.). Representative oils and fats include: maize, soybean, safflower, coconut, palm, canola, olive, castor, sesame, cottonseed, mustard, medium chain triglycerides, almond, apricot, avocado, grape seed, pumpkin, watermelon, bitter gourd, acai, black seed, borneo tallow nut, hemp oil, niger seed, fatty acids, pine nut, wheat germ, rice bran, cashew nut, hazel nut, walnut, perilla, pumpkin seed, chia seed, illipe butter, mango kernel, shea butter, and phospholipids, and combinations of these oils and fats. Animal derived fats and oils include beef tallow, butter fat, fish oil and lard, and combinations of these fats and oils.

The spacing agent incorporated into the reaction mixture when compared to reaction systems not containing spacing agent allows the caramelization reaction to continue for a longer period, thus encouraging the formation of darker color. As a result, the viscosity of the reaction mixture tends to be lower both because of the presence of the spacing agent and because of the controlled rate of polymerization of the sugar molecules. The spacing agent also allows reaction vapors and volatile byproducts to escape more readily, which allows for uniform reactant distribution during the reaction process.

The reaction system for preparing the brown color ingredient consists of a heated vessel (cooker) with typically coils of heated jacket or injected steam. The vessel is made from non-reactive materials such as stainless steel or glass lined vessels that have a mixing apparatus. The mixing apparatus is typically an impeller and typically has multiple pitched blade turbines to maximize axial mixing. Flat turbines can also be used to maximize radial mixing depending on where the heat source is located. The vessel has the capability to add and remove products and ingredients before, during and after the cook; and has the ability to add or remove pressure through vents and pumps before, during and after the cook.

### EXAMPLES OF THE INVENTION

The following examples describe the process and the brown color composition in further detail.

The following examples are brown color formulations not containing a spacing agent. The reaction conditions and properties of the final color reaction product are also provided.

Into the reaction system described above, a comparative formulation was prepared using 50 lbs. (22.7 kg) high fructose corn syrup and 10 grams of hydrochloric acid.

The above reactants were heated to 300° F. (148.9° C.) at 0 psi in the above cooker for five hours once the syrup reached 300° F. (148.9° C.) and was then cooled by adding 5 lbs. (2.3 kg) of water over 10 minutes to the reaction.

The resulting product was deemed to have no usable brown color. The reaction product was turbid in water and had particles that settled to the bottom under 24 hour ambient temperature storage conditions. The absorbance at 610 nm of a 0.1 w/v solution was 0.465 but with a 700 nm absorbance value of 0.441. These data indicate a turbid solution with little color development. Black particles appeared to be suspended in the solution. These properties would not be acceptable to provide a uniform brown color for food or beverage products.

A second comparative example was prepared without spacing agent or acid. Into the cooker above was loaded 50 lbs. (22.7 kg) of high fructose corn syrup, which was heated to 300° F. (148.9° C.) at 0 psi, with a 5 hour cook time once the syrup reached 300° F. (148.9° C.). Cooling of the reaction product involving incorporation of 7 lbs. (3.2 kg) of water over 10 minutes to the cooker. The results of this comparative run provided a color intensity of the reaction product of 0.017 (Absorbance of a 0.1% weight/volume solution in deionized water through a 1 cm cuvette) with a hue index of 5.2 (10 times the log of ABS 510 nm/ABS 610 nm). Viscosity was 2500 cP. The color of this reaction product was too low for use as a brown color for food or beverage applications.

In a third comparative example, without acid or spacing agent, 50 lbs. (22.7 kg) of high fructose corn syrup was combined with 0.5 lbs. (0.23 kg) of sodium hydroxide and heated to 300° F. (148.9° C.) at 0 psi for 7 hours once the syrup reached 300° F. Cooling involved incorporation of 10 lbs. (4.5 kg) of water into the reaction mix. The result of this comparative run was that the color intensity of the reaction product was 0.057 with a hue index of 5.9 (10 times the log of ABS 510 nm/ABS 610 nm). The reaction product was unstable in 5-30% weight/weight sodium chloride solution. It was also unstable in an acidic medium below ph 3, developing haze and precipitation. The color was also not stable in beer. The product viscosity was 5000 cP at 20° C. This is an example of a typical Class I caramel cook and can be used in applications such as bakery and confection.

In a fourth comparative example, a typical class IV color run without a spacing agent, 37 lbs. (16.8 kg) of 80 DE glucose syrup was heated to 265° F. (129.4° C.) and 50 psi. Then 13 lb. (5.9 kg) of 70% ammonium bisulfite was injected over 2 hours and the reactants were heated to 265° F. (129.4° C.) at 50 psi for 2 hours. After 2 hours the mixture was cooled to below 180° F. (82.3° C.) with cool water in the cooling coils over 4 minutes. The result of this comparative run was that the color intensity of the reaction product was 0.223 with a hue index of 4.0 (10 times the log of ABS 510 nm/ABS 610 nm) and a resinification time of 25 hours.

In a fifth comparative example, a typical class III color run without a spacing agent, 50 lbs. (22.7 kg) of 80 DE glucose syrup was combined with 10 lb (4.5 kg) of 28% ammonium hydroxide and heated to 280° F. (132.8° C.) at 30 psi for 2 hours. Cooling involved running cool water through the thermal exchange coils in the vessel. The result of this comparative run was that the color intensity of the reaction product was 0.194 with a viscosity of 7000 cP at 20° C. This product was not stable in 5-30% weight/weight sodium, calcium or potassium chloride solutions or in beer.

In a sixth comparative example without a spacing agent, 50 lbs. (22.7 kg.) of 79 DE glucose syrup was combined with 4 lbs. (1.8 kg) of sodium hydroxide and 2 lb (0.91 kg) of sodium metabisulfite powder and heated to 300° F. (148.9° C.) at 0 psi for 3 hours once the syrup reached 300° F. (148.9° C.). Cooling involved incorporation of 10 lbs. (4.5 kg) of water into the reaction mix. The result of this comparative run was that the color intensity of the reaction product was 0.040 with a hue index of 5.5. The product viscosity was 2000 cP at 20° C. This is an example of a Class II caramel cook without a spacing agent.

The following examples are brown color formulations containing a spacing agent. The reaction conditions and properties of the final caramel color reaction product are also provided.

In inventive example 1, 10 lbs. (4.5 kg) of 70% sorbitol was combined with 50 lbs. (22.7 kg) glucose syrup and 10 g hydrochloric acid. The mixture was heated to 300° F. (148.9° C.) for 5 hours once the reactants reached 300° F. (148.9° C.) at 5 psi pressure. Cooling of the reaction contents was with 5 lbs. (2.3 kg) water added to the cooker. The reaction product had a color intensity of 0.053 with a hue index of 4.01. Viscosity was 2000 cP at 20° C. Lower hue, viscosity and higher color intensity than a comparative example 1 and 2.

In inventive example 2, 10 lbs. (4.5 kg) of 70% sorbitol was combined with 50 lbs. (22.7 kg) glucose syrup and 10 g hydrochloric acid. The mixture was heated to 300° F. (148.9° C.) for 8 hours once the reactants reached 300° F. (148.9° C.), at 5 psi pressure. Cooling of the reaction contents was with 10 lbs. (4.5 kg) water added to the cooker. The reaction product had a color intensity of 0.101 with a hue index of 4.1. Viscosity was 4300 cP at 20° C., and a lower hue and higher color intensity than comparative examples 1 and 2.

In inventive example 3, 10 lbs. (4.5 kg) of 70% sorbitol was combined with 50 lbs. (22.7 kg) glucose syrup and 10 g hydrochloric acid. The mixture was heated to 300° F. (148.9° C.) for 7 hours once the reactants reached 300° F. (148.9° C.) and 0 psi pressure. Cooling of the reaction contents was with 10 lbs. (4.5 kg) water added to the cooker. The reaction product had a color intensity of 0.080 with a hue index of 4.1. Viscosity was 2100 cP at 20° C. There was no precipitation of the reaction product in a 0.1M acid solution to a pH of 0.1, no precipitation in a 20% weight/weight sodium chloride water solution and no precipitation in a pilsner beer.

In inventive example 4, a typical burnt sugar with a spacing agent and acid, 2 lbs. (0.91 kg) sunflower oil was combined with 50 lbs. (22.7 kg) glucose crystals and 10 g hydrochloric acid. The mixture was heated to 300° F. (148.9° C.) for 5 hours once the reactants reached 300° F. (148.9° C.), under atmospheric pressure conditions. Cooling of the reaction contents was with 5 lbs. (2.3 kg) water added to the cooker. The oil portion was decanted from the reaction product. The water soluble brown color was measured for color intensity and hue index. These results provided a color intensity of 0.061 with a hue index of 3.6 (10 times the log of ABS 510 nm/ABS 610 nm). Viscosity was 2800 cP at 20° C.

In inventive example 5, a typical class I with a spacing agent and acid, 10 lbs. (4.5 kg) of 42 DE corn syrup was combined with 50 lbs. (22.7 kg) high fructose corn syrup and 100 g phosphoric acid. The mixture was heated to 300° F. (148.9° C.) under atmospheric pressure conditions. An additional 700 g of phosphoric acid was injected into the cooker over 180 minutes once the reaction temperature of 300° F. (148.9° C.) was reached. The mixture was cooked for 7 hours once the reactants reached 300° F. (148.9° C.). Cooling of the reaction contents was with 7 lbs. (3.2 kg) water added to the cooker. The reaction product had a color intensity of 0.090 with a hue index of 4.5 log (ABS 510 nm/ABS 610 nm). The reaction product was stable in a pH 0.5 water solution, as well as in beer, and in a 20% weight/weight sodium chloride solution. Furfuryl alcohol and 4-Mel was non-detectable. Viscosity was 3000 cP at 20° C.

In inventive example 6, a typical class IV with a spacing agent, 35 lbs. (15.9 kg) of 80 DE glucose syrup was mixed with 2 lb (0.91 kg) of 90% glycerol and was heated to 265° F. (129.4° C.) and 50 psi. Then 13 lb (5.9 kg) of 70% ammonium bisulfite was injected over 2 hours and then reactants were heated to 265° F. (189.4° C.) at 50 psi for 2 additional hours. Then, the mixture was cooled to below 180° F. (82.2° C.) with cool water in the cooling coils over 4 minutes. The result of this inventive run was that the color intensity of the reaction product was 0.224 with a hue index of 4.0 log (ABS 510 nm/ABS 610 nm) and a resinification time of 42 hours.

In inventive example 7, a typical class III with a spacing agent, 45 lbs. of 80 DE glucose syrup was combined with 5 lb (2.27 kg) of 70% sorbitol and 10 lb. (4.5 kg) of 28% ammonium hydroxide, and heated to 280° F. (137.8° C.) at 30 psi for 2 hours once the reactants reached 280° F. (132.8° C.). Cooling involved running cool water through the thermal exchange coils in the vessel. The result of this inventive run was that the color intensity of the reaction product was 0.194 with a viscosity of 2000 cP at 20° C. This product is stable in 5-30% weight/weight sodium, calcium or potassium chloride solutions and in beer.

In inventive example 8, 40 lbs. of high fructose corn syrup was combined with 0.5 lbs. (0.23 kg) of sodium hydroxide and 10 lb (4.5 kg) of glycerol and heated to 300° F. (148.9° C.) at 0 psi for 7 hours once the syrup reached 300° F. (148.9° C.). Cooling involved incorporation of 10 lbs. (4.5 kg) of water into the reaction mix. The result of this comparative run was that the color intensity of the reaction product was 0.057 with a hue index of 5.9 (10 times the log of ABS 510 nm/ABS 610 nm). The reaction product was unstable in 15-30% weight/weight sodium chloride solution. It was also unstable in an acidic medium below pH 2.5, developing haze and precipitation. The color was not stable in beer. The product viscosity was 2000 cP at 20° C. This viscosity is lower than example This is an example of a Class I caramel cook with a spacing agent.

In inventive example 9, 40 lbs. (18.2 kg) of 79 DE glucose syrup was combined with 4 lbs. (1.8 kg) of sodium hydroxide, 2 lb (0.91 kg) of sodium metabisulfite powder and 10 lb (4.5 kg) of glycerol and heated to 300° F. (148.9° C.) at 0 psi for 3 hours once the syrup reached 300° F. (148.9° C.). Cooling involved incorporation of 10 lbs. (4.5 kg) of water into the reaction mix. The result of this comparative run was that the color intensity of the reaction product was 0.040 with a hue index of 5.5. The product viscosity was 1000 cP at 20° C. This is an example of a Class II caramel cook with a spacing agent.

In inventive example 10, without acid but with spacing agent, 40 lbs. (18.2 kg) of high fructose corn syrup was combined with 0.5 lbs. (0.23 kg) of sodium hydroxide and 20 lb. (9.1 kg) of sunflower oil and heated to 300° F. (148.9° C.) at 0 psi for 5 hours once the syrup reached 300 ° F. (148.9° C.). Cooling involved incorporation of 10 lbs. (4.5 kg) of water into the reaction mix. The oil portion was decanted from the reaction product. The water soluble brown color was measured for color intensity, viscosity and hue index. The result of this comparative run was that the color intensity of the reaction product was 0.057 with a hue index of 5.8 (10 times the log of ABS 510 nm/ABS 610 nm). The product viscosity was 3000 cP at 20° C. This is an example of a Class I caramel cook with a spacing agent. The use of the spacing agent in preparing the caramel color under any of the Class I-IV procedures allows for production of a product with a higher color intensity, and with lower hue index.

While the present invention has been illustrated by a description of various embodiments, and while these embodiments have been described in some detail, they are not intended to restrict or in any way limit the scope of the appended claims to such detail. Additional advantages and modifications will readily appear to those skilled in the art. The various features of the invention may be used alone or in any combination depending on the needs and preferences of the user. This has been a description of the present invention, along with methods of practicing the present invention as currently known. However, the invention itself should only be defined by the appended claims.

What is claimed is:

1. A method of forming a caramel, burnt sugar, or cooked plant juice composition, the method comprising:
heating a browning ingredient source in the presence of a non-browning spacing agent at a temperature which is effective to produce a high color intensity brown color, wherein the heating occurs in the absence of any added reactive sulfonium compound or ammonium compound.

2. The method of claim 1, wherein the heating is conducted at the temperature of between 245° F. (118.3° C.) and 300° F. (148.9° C.).

3. The method of claim 1, wherein the heating occurs within a pressure range of 20 psi to 80 psi.

4. The method of claim 1, wherein the heating occurs within a pH range of −0.5 to 2.5.

5. The method of claim 1, wherein the caramel, burnt sugar, or cooked plant juice composition forms a Class I caramel with color intensity up to 0.600.

6. The method of claim 4, wherein the caramel, burnt sugar, or cooked plant juice composition forms a brown color that is stable in beverages with pH up to 7.

7. The method of claim 4, wherein the caramel, burnt sugar, or cooked plant juice composition forms a brown color that is stable in salt food products with salt concentrations up to 20% by weight.

8. The method of claim 4, wherein the caramel, burnt sugar, or cooked plant juice composition forms a brown color that is stable in beer and liquor applications.

9. The method of claim 4, wherein the caramel, burnt sugar, or cooked plant juice composition has a brown caramelized color having a hue index less than 4.5.

10. The method of claim 1, wherein the caramel, burnt sugar, or cooked plant juice composition forms a Class I caramel.

11. The method of claim 1, wherein the caramel, burnt sugar, or cooked plant juice composition forms a cooked plant juice.

12. The method of claim 1, wherein the caramel, burnt sugar, or cooked plant juice composition forms a burnt sugar.

13. The method of claim 1, wherein the spacing agent is selected from the group consisting of a polyol, a plant juice, an oligosaccharide, an oil, a fat and combinations thereof.

14. The method of claim 1, wherein the spacing agent comprises the polyol selected from the group consisting of glycerol, erythritol, mannitol, sorbitol (glucitol), arabitol, xylitol, lactitol, arabinitol, galactitol (dulcitol), ribitol, isomalt, hydrogenated starch hydrolysates, and combinations thereof.

15. The method of claim 1, wherein the spacing agent comprises the plant juice selected from juice concentrates selected from the group consisting of pear juice concentrate, prune juice concentrate, peach juice concentrate, cherry juice concentrate, and combinations thereof.

16. The method of claim 1 wherein the spacing agent comprises the oligosaccharide, the oligosaccharide having a dextrose equivalence value of between 15 and 70, inclusively.

17. The method of claim 1 wherein the spacing agent comprises the oil or the fat, the oil or the fat being selected from the group consisting of beef tallow, butter fat, fish oil, lard, maize, soybean, safflower, coconut, palm, canola, olive, castor, sesame, cottonseed, mustard, medium chain triglycerides, almond, apricot, avocado, grape seed, pumpkin, watermelon, bitter gourd, acai, black seed, borneo tallow nut, hemp oil, niger seed, fatty acids, pine nut, wheat germ, rice bran, cashew nut, hazel nut, walnut, perilla, pumpkin seed, chia seed, illipe butter, mango kernel, shea butter, phospholipids, and combinations thereof.

18. The method of claim 1 wherein the browning ingredient source is selected from the group consisting of glucose, fructose, high DE corn syrup, sucrose, xylose, plant juices, syrups and extracts containing reducing sugars, and combinations thereof.

19. A method of forming a caramel, burnt sugar, or cooked plant juice composition, the method comprising: heating a browning ingredient source in the presence of a non-browning spacing agent at a temperature which is effective to produce a high color intensity brown color.

20. The method of claim 18, wherein the caramel, burnt sugar, or cooked plant juice composition forms a Class II caramel.

21. The method of claim 18, wherein the caramel, burnt sugar, or cooked plant juice composition forms a Class II caramel with color intensity up to 1.000.

22. The method of claim 18, wherein the caramel, burnt sugar, or cooked plant juice composition forms a Class III caramel.

23. The method of claim 18, wherein the caramel, burnt sugar, or cooked plant juice composition forms a Class III caramel with color intensity up to 1.000.

24. The method of claim 18, wherein the caramel, burnt sugar, or cooked plant juice composition forms a Class IV caramel.

25. The method of claim 18, wherein the caramel, burnt sugar, or cooked plant juice composition forms a Class IV caramel with color intensity up to 1.000.

26. The method of claim 18, wherein the caramel, burnt sugar, or cooked plant juice composition forms a Class IV caramel with resinification time up to 600 hours.

27. The method of claim 18, wherein the spacing agent is selected from the group consisting of a polyol, a plant juice, an oligosaccharide, an oil, a fat and combinations thereof.

28. The method of claim 18, wherein the spacing agent comprises the polyol selected from the group consisting of glycerol, erythritol, mannitol, sorbitol (glucitol), arabitol, xylitol, lactitol, arabinitol, galactitol (dulcitol), ribitol, isomalt, hydrogenated starch hydrolysates, and combinations thereof.

29. The method of claim 18, wherein the spacing agent comprises the plant juice selected from juice concentrates selected from the group consisting of pear juice concentrate, prune juice concentrate, peach juice concentrate, cherry juice concentrate, and combinations thereof.

30. The method of claim 18, wherein the spacing agent comprises the oligosaccharide, the oligosaccharide having a dextrose equivalence value of between 15 and 70, inclusively.

31. The method of claim 18, wherein the spacing agent comprises the oil or the fat, the oil or the fat being selected from the group consisting of beef tallow, butter fat, fish oil, lard, maize, soybean, safflower, coconut, palm, canola, olive, castor, sesame, cottonseed, mustard, medium chain triglycerides, almond, apricot, avocado, grape seed, pumpkin, watermelon, bitter gourd, acai, black seed, borneo tallow nut, hemp oil, niger seed, fatty acids, pine nut, wheat germ, rice bran, cashew nut, hazel nut, walnut, perilla, pumpkin seed, chia seed, illipe butter, mango kernel, shea butter, phospholipids, and combinations thereof.

32. The method of claim 19 wherein the browning ingredient source is selected from the group consisting of glucose, fructose, high DE corn syrup, sucrose, xylose, plant juices, syrups and extracts containing reducing sugars, and combinations thereof.

33. A caramel, burnt sugar, or cooked plant juice composition, the composition comprising:
a browning ingredient source in a weight percentage of between 3% and 98%, inclusively;
a spacing agent in the weight concentration of between 1% and 90%, inclusively; and
an acid weight concentration of between 0.002% and 20.0%, inclusively,
wherein the composition comprises an absence of reactive sulfonium compound or ammonium compound.

34. The composition of claim 31, wherein the spacing agent is selected from the group consisting of a polyol, a plant juice, an oligosaccharide, an oil, and a fat.

35. The composition of claim 31, wherein the spacing agent comprises the polyol selected from the group consisting of glycerol, erythritol, mannitol, sorbitol (glucitol), arabitol, xylitol, lactitol, arabinitol, galactitol (dulcitol), ribitol, isomalt, hydrogenated starch hydrolysates, and combinations thereof.

36. The composition of claim 31, wherein the spacing agent comprises the plant juice selected from juice concentrates selected from the group consisting of pear juice concentrate, prune juice concentrate, peach juice concentrate, cherry juice concentrate, and combinations thereof.

37. The composition of claim 31, wherein the spacing agent comprises the oligosaccharide, the oligosaccharide having a dextrose equivalence value of between 15 and 70, inclusively.

38. The composition of claim 31, wherein the spacing agent comprises the oil or the fat, the oil or the fat being selected from the group consisting of beef tallow, butter fat, fish oil, lard, maize, soybean, safflower, coconut, palm, canola, olive, castor, sesame, cottonseed, mustard, medium chain triglycerides, almond, apricot, avocado, grape seed, pumpkin, watermelon, bitter gourd, acai, black seed, borneo tallow nut, hemp oil, niger seed, fatty acids, pine nut, wheat germ, rice bran, cashew nut, hazel nut, walnut, perilla, pumpkin seed, chia seed, illipe butter, mango kernel, shea butter, phospholipids, and combinations thereof.

39. The composition of claim 31, wherein the composition has a brown caramelized color having a hue index less than 4.5.

40. The composition of claim 31, wherein the composition beer stable and 20% weight/weight sodium, calcium or potassium chloride stable.

41. The composition of claim 31, wherein the caramel, burnt sugar, or cooked plant juice composition forms a brown color that is stable in beverages up to pH 7.

42. The composition of claim 31 wherein the browning ingredient source is selected from the group consisting of glucose, fructose, high DE corn syrup, sucrose, xylose, plant juices, syrups and extracts, containing reducing sugars, and combinations thereof.
